(19) United States
(12) Patent Application Publication
(10) Pub. No.: US 2017/0163955 A1
(43) Pub. Date: Jun. 8, 2017

(54) METHOD AND DEVICE FOR PLAYING VIDEO

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Jijian ZHENG, Tianjin (CN)

(21) Appl. No.: 15/246,461

(22) Filed: Aug. 24, 2016

Related U.S. Application Data
(63) Continuation of application No. PCT/CN2016/089360, filed on Jul. 8, 2016.

(30) Foreign Application Priority Data
Dec. 3, 2015 (CN) 201510885301.1

(51) Int. Cl. H04N 9/802; G11B 27/28

(52) U.S. Cl. CPC H04N 9/802; G11B 27/28; G11B 2020/10759

(57) ABSTRACT

An embodiment of the present disclosure discloses a method for playing a video. The method comprises: parsing a file to be played to obtain one video stream and at least two audio streams by a player and saving the video and audio streams into a buffer; selecting a certain audio stream as a first audio stream, and obtaining the stream and the first audio stream from the buffer for decoding and playing; receiving an audio switching instruction, and determining one other channel of audio as a second audio stream according to the audio switching instruction; stopping decoding the first audio stream, and obtaining the video stream and the second audio stream from the buffer for decoding and playing. By using the method for playing a video, reparsing and readdressing are avoided; therefore, the time of addressing is saved, and the efficiency of switching is improved.

### CROSS-REFERENCE TO RELATED APPLICATIONS

This application is a continuation of International Application No. PCT/CN2016/089360 filed on Jul. 8, 2016, which is based upon and claims priority to Chinese Patent Application No. 201510885301.1, entitled “METHOD AND DEVICE FOR PLAYING VIDEO”, filed on Dec. 3, 2015, and the entire contents of all of which are incorporated herein by reference.

### FIELD OF TECHNOLOGY

The present disclosure generally relates to the technical field of Internet, and in particular, to a method and a device for playing a video.

### BACKGROUND

At presents, users generally use players of terminal devices to watch videos. For example, the players of a smart phone, a computer and a smart IV all may be enabled to play video data.

The inventor has found out in the process of implementing the present disclosure that some video data includes multi-channel audio; for example, video data of foreign-language TV series, such as US TV series, Korea TV series and the like, generally includes a channel of Chinese audio and a channel of foreign-language audio. For instance, US TV series includes English audio and Korea TV series includes Korea audio. For playing the video data including multi-channel audio, a player is usually configured with a plurality of audio tracks, each of which corresponds to one channel of audio.

In the process of playing such video data, if there is a need on audio switching, the switching target audio needs to be parsed in the switching process, and readdressing is performed to find out a PTS (Presentation Time Stamp) matched with the current video; this is time-consuming. If the audio is in a streaming format without index, addressing will take longer time, leading to obvious hysteresis and influence on time of playing the video by the player.

Hence, a technical problem urgent to be solved by a person skilled in the art is to provide a method for playing a video and a player, which are used to solve the problem of long time consumed by a player switching different audios.

### SUMMARY

Embodiments of the present disclosure disclose method and an apparatus for selecting a video output mode to overcome the defect in the prior art that a user needs to press a key to switch video output modes.

To solve the problem above, according to an embodiment of the present disclosure, there is provided a method for playing a video, comprising: at an electronic device;
parsing a file to be played to obtain one video stream and at least two audio streams by a player and saving the video and audio streams into a buffer;
selecting a certain audio stream as a first audio stream, and obtaining the video stream and the first audio stream from the buffer for decoding and playing;
receiving an audio switching instruction, and determining one other channel of audio as a second audio stream according to the audio switching instruction;
stopping decoding the first audio stream, and obtaining the video stream and the second audio stream from the buffer for decoding and playing.

According to an embodiment of the present disclosure, there is further provided an electronic device, comprising:
at least one processor; and a memory communicably connected with the at least one processor for storing instructions executable by the at least one processor, wherein execution of the instructions by the at least one processor causes the at least one processor to:
parse a file to be played to obtain one video stream and at least two audio streams and save the obtained video and audio streams into a buffer;
select a certain audio stream as a first audio stream, and obtain the video stream and the first audio stream from the buffer for decoding and playing, and stop decoding the first audio stream, and obtain the video stream and a second audio stream from the buffer for decoding and playing;
receive pan audio switching instruction, and determine one other channel of audio as the second audio stream according to the audio switching instruction.

According to an embodiment of the present disclosure, there is provided a computer program, comprising computer-readable codes, wherein when the computer-readable codes are run on a terminal device, the terminal device is led to execute the method for playing a video above.

According to an embodiment of the present disclosure, there is provided a non-transitory computer readable medium, storing executable instructions that, when executed by an electronic device, cause the electronic device to: parse a file to be played to obtain one video stream and at least two audio streams by a player and saving the video and audio streams into a buffer; select a certain audio stream as a first audio stream, and obtaining the video stream and the first audio stream from the buffer for decoding and playing; receive an audio switching instruction, and determining one other channel of audio as a second audio stream according to the audio switching instruction; stop decoding the first audio stream, and obtain the video stream and the second audio stream from the buffer for decoding and playing.

Compared with the prior art, the embodiments of the present disclosure has the following advantages: a player is activated to parse a file to be played to obtain one video stream and at least two audio streams, and save the obtained video and audio streams into a buffer, i.e., decode and save the audio streams into the buffer on initialization. After a first audio stream is selected, and decoded and played synchronously with the video stream, if an audio switching instruction is received, a second audio stream for switching is determined. Decoding of the first audio stream is stopped, and the video stream and the second audio stream are obtained from the buffer for decoding and playing. Reparsing and readdressing are avoided; therefore, the time of addressing is saved, and the efficiency of switching is improved.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flow diagram of a method for playing a video in accordance with some embodiments.

FIG. 2 is a step flow diagram of a method for playing a video in accordance with some embodiments.

FIG. 3 is a structural block diagram of a player device in accordance with some embodiments

FIG. 4 is a structural block diagram of a player device in accordance with some embodiments

FIG. 5 schematically shows a block diagram of an electronic device for executing a method according to the present disclosure.

FIG. 6 schematically shows a storage unit for holding or carrying program codes for executing a method according to the present disclosure.

### DETAILED DESCRIPTION

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part of embodiments of the present disclosure rather than all. On the basis of the embodiments in the present disclosure, all the other embodiments obtained by a person skilled in the art without creative work should fall into the scope of protection of the present disclosure.

For a multi-audio data video file, a player typically separates only one channel of video and one selected channel of audio from the video file by parsing; if needing to switch to a second audio stream during playing, the second audio stream needs to be parsed, and readdressing is carried out to find out a time stamp matched with the current video stream, for example, a PTS (Presentation Time Stamp) the video and the second channel of audio starting from the PTS are then played, wherein the PTS is a time stamp relative to system reference during playing by a decoder, and the system reference can be interpreted as the time when the decoder should start reading data from a magnetic disk. In case of multi-audio switching during playing, reparsing and readdressing lead to relatively long switching time, which may influence coned playing of the video.

One core concept of the embodiments of the present disclosure is as follows: a player is activated to parse a file to be played to obtain one video stream and at least two audio streams, and save the obtained video and audio streams into a buffer. Specifically, the audio streams are decoded and saved into the buffer on initialization. After a first audio stream is selected, and decoded and played synchronously with the video stream, if an audio switching instruction is received, a second audio stream for switching is determined. Decoding of the first audio stream is stopped, and the video stream and the second audio stream are obtained from the buffer for decoding and playing. Reparsing and readdressing are avoided; therefore, the time of addressing is saved, and the efficiency of switching is improved.

### A First Embodiment

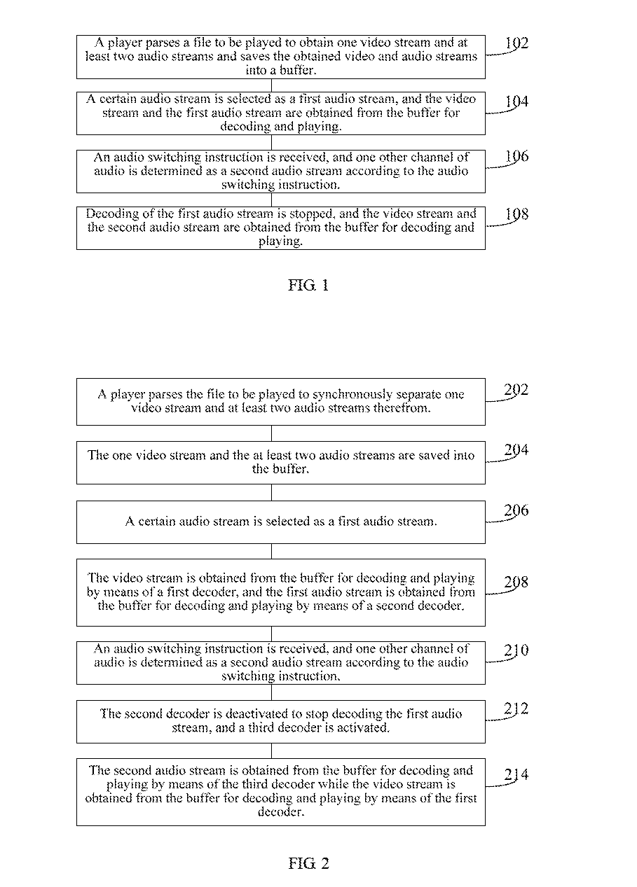

Referring to FIG. 1, which shows the step flow diagram of one embodiment of the method for playing a video of the present disclosure, the method may specifically include the following steps: Step S102, a player parses a file to be played to obtain one video stream and at least two audio streams and saves the obtained video and audio streams into a butler.

In this embodiment of the present disclosure, the player detects the video file to be played. Concerning a multi-audio file to be played, the file to be played includes one video stream and at least two audio streams. Hence, the player may parse the file to be played to obtain one video stream and at least two audio streams, and may save the obtained video and audio streams into the buffer, e.g., an ES (Elementary Stream) buffer, wherein an ES includes a continuous stream of video, audio or data. Therefore, the video code stream and the audio streams of the file to be played are directly saved in the buffer, so that the parsed audio streams can be extracted from the buffer in subsequent audio switching. As the audio streams are already parsed, parsing and addressing may be avoided during switching. As a result, the audio streams can be obtained based on a PTS, leading to more fluent audio switching.

Step S104, a certain audio stream is selected as a first audio stream, and the video stream and the first audio stream are obtained from the buffer for decoding and playing.

A user can freely select which one channel of audio is to be played before playing, or a certain channel of audio is selected by default by the player; the selected audio stream is regarded as the first audio stream. Since the parsed one video stream and at least two audio streams are saved in the buffer, the video stream and the first audio stream may be directly obtained from the buffer, and then decoded and played by means a corresponding decoders.

Step S106, an audio switching instruction is received, and one other channel of audio is determined as a second audio stream according to the audio switching instruction.

When the player plays a video, an audio track is used to bear each audio stream. The audio track is a track for playing audio in the player. In case of a plurality of audio streams, the player is configured with a plurality of audio tracks, for example, one for playing Mandarin Chinese and another for playing Cantonese. During playing, if the user wants to switch the audio tracks, i.e., switch the audio streams, the corresponding audio switching instruction may be sent. The audio switching instruction may carry audio information selected for switching therein. The player correspondingly receives the audio switching instruction, and determines the audio information for switching according to the audio switching instruction, thereby selecting one other channel of data than the first audio stream as the second audio stream. For example, the first audio stream is Mandarin Chinese, and the audio stream corresponding to Cantonese is selected as the second audio stream.

Step S108, decoding of the first audio stream is stopped, and the video stream and the second audio stream are obtained from the buffer for decoding and playing.

After the second audio stream is determined, the decoding of the now playing first audio stream is stopped; at this moment, a DTS (Decoder Time Stamp) of current decoding and playing is restored in the buffer. The DTS is synchronous with the PTS; therefore, the parsed video stream and second audio stream may be obtained from the buffer based on the DTS in succession. Specifically, the DTS is a time stamp of a decoder relative to system reference during decoding, and the system reference can be interpreted as the time when the decoder should start reading data from a magnetic disk. The video stream and the second audio stream are decoded and played.

In conclusion, the player parses the file to be played to obtain one video stream and at least two audio streams, and saves the obtained video and audio streams into the buffer, i.e., decodes and saves the audio streams into the butler on initialization. After the first audio stream is selected, and decoded and played synchronously with the video stream, if the audio switching instruction is received, the second audio stream for switching is determined. Decoding of the first audio stream is stopped, and the video stream and the second audio stream are obtained from the buffer for decoding and playing. Reparsing and readdressing are avoided; therefore, the time of addressing is saved, and the efficiency of switching is improved.

### A Second Embodiment

Referring to FIG. 2, which shows the step flow diagram of another embodiment of the method for playing a video of the present disclosure, the method may specifically include the following steps: Step S202, a player parses the file to be played to synchronously separate one video stream and at least two audio streams therefrom.

In this embodiment of the present disclosure, the player may be installed in various smart terminals, such as a smart phone, a smart TV, a tablet computer and so on. When the player parses a file to be played, for a multi-audio file to be played that includes, e.g., Mandarin Chinese audio and Cantonese audio, the player is able to identify the audio and video streams, thereby synchronously separating one video stream and at least two audio streams therefrom, for example, one video stream, one Mandarin Chinese audio stream and one Cantonese audio stream. In an optional embodiment of the present disclosure, the step of parsing the file to be played to synchronously separate one video stream and at least two audio streams therefrom by the player includes: identifying data of a plurality of streams in the file to be played by the payer using a multistage parser; synchronously parsing the identified data of each stream to separate one video stream and at least two audio streams therefrom.

The player mentioned in this embodiment of the present disclosure is provided with the multistage parser. The multistage parser, differing from a conventional parser that is only capable of separating one video stream and one audio stream at a time, is capable of synchronously parsing a plurality of video streams and audio streams. That is, when the multistage parser is used to parse the file to be played, the data of streams in the file to be played may be identified according to interface. As a result, the data of a plurality of streams can be identified; the identified data of each stream is parsed synchronously to obtain the data of a plurality of streams, including one video stream and at least two audio streams. By means of synchronous parsing, consistent decoder time stamp of the streams can be ensured to facilitate subsequent switching.

Step S204, the one video stream and the at least two audio streams are saved into the buffer.

The separated one video stream and at least two audio streams are saved into an ES buffer, so that the data can be obtained from the ES buffer for playing in the subsequent video playing process. Alternatively, data may be continuous buffered and saved into the buffer in the playing process.

Step S206, a certain audio stream is selected as a first audio stream.

Step S208, the video stream is obtained from the buffer for decoding and playing by means of a first decoder, and the first audio stream is obtained from the buffer for decoding and playing by means of a second decoder.

A user can freely select which one channel of audio is to be played before playing, or a certain channel of audio is selected by default by the player, for example, Mandarin Chinese audio. The selected audio stream is regarded as the first audio stream, i.e., the Mandarin Chinese audio stream is regarded as the first audio stream. Since the parsed one video stream and at least two audio streams, e.g., one video stream, one Mandarin Chinese audio stream and one Cantonese audio stream, are saved in the buffer, the video strewn may be directly obtained from the buffer by means of the first decoder, e.g., a video decoder, and then is decoded and played. Meanwhile, the first audio stream is directly obtained from the buffer by means of the second decoder, e.g., an audio decoder, and then decoded and played. For instance, the Mandarin Chinese audio stream is obtained for decoding and playing.

Step S210, an audio switching instruction is received, and one other channel of audio is determined as a second audio stream according to the audio switching instruction,

When the player plays a video, an audio track is used to bear each audio stream. The audio track is a track for playing audio in the player. In case of a plurality of audio streams, the player is configured with a plurality of audio tracks, for example, one for playing Mandarin Chinese and another for playing Cantonese. During playing, if the user wants to switch the audio tracks, i.e., switch the audio streams, the corresponding audio switching instruction may be sent. The audio switching instruction may carry audio information selected for switching therein. The player correspondingly receives the audio switching instruction, and determines the audio information for switching according to the audio switching instruction, thereby selecting one other channel of data than the first audio stream as the second audio stream. For example, the first audio stream is Mandarin Chinese, and the audio stream corresponding to Cantonese is selected as the second audio stream.

Step S212, the second decoder is deactivated to stop decoding the first audio stream, and a third decoder is activated.

In order to avoid mixed sounds when the second audio stream is played, the second decoder needs to be deactivated upon receiving the audio switching instruction, thereby stopping decoding and playing the now playing first audio stream. Meanwhile, the third decoder is activated, which can be the audio decoder.

Step S214, the second audio stream is obtained from the buffer for decoding and playing by means of the third decoder while the video stream is obtained from the buffer for decoding and playing by means of the first decoder.

Specifically, the operation of obtaining the second audio stream from the buffer for decoding and playing by means of the third decoder includes: obtaining a decoder time stamp from the buffer by the third decoder; obtaining the second audio stream according to the decoder time stamp, and decoding and playing the second audio stream.

The one parsed video stream and other at least two audio streams parsed are saved in the buffer, i.e., the video stream and the second audio stream needing to be played are saved. The DTS of current decoding and playing is recorded in the buffer, and synchronous with the PTS, and therefore, readdressing to PTS during switching can be avoided. The video stream and the audio stream are directly obtained according to the DTS ire the buffer instead.

Specifically, the video stream is obtained from the buffer by means of the first decoder according to the DTS, and the first video stream is decoded continuously. Meanwhile, the second audio stream is obtained from the buffer by means of the third decoder according to the DTS, and decoded. Therefore, the video stream and the audio stream are directly obtained according to the DTS for decoding and playing. Fast audio stream switching thus is realized.

In conclusion, according to this embodiment of the present disclosure, the player is activated to parse the file to be played to obtain one video stream and at least two audio streams, and save the obtained video and audio streams into a buffer, i.e., decode and save the audio streams into the buffer on initialization. After the first audio stream is selected, and decoded and played synchronously with the video stream if the audio switching instruction is received, the second audio stream for switching is determined. Decoding of the first audio stream is stopped and the video stream and the second audio stream are obtained from the buffer for decoding and playing. Reparsing and readdressing are avoided; therefore, the time of addressing is saved, and the efficiency of switching is improved. The third decoder obtains the decoder time stamp from the buffer, obtains the second audio stream according to the decoder time stamp, and decodes and plays the second audio stream. By determining the playing starting point of the second audio stream according to the decoder time stamp, the time is more accurate, and more fluent audio switching can be achieved.

It needs to be noted that in regard to the method embodiments, for the sake of simple descriptions, they are all expressed as combinations of a series of actions; however, a person skilled in the art should know that the embodiments of the present disclosure are not limited by the described order of actions, because some steps may be carried out in other orders or simultaneously according to the embodiments of the present disclosure. For another, a person skilled in the art should also know that the embodiments described in the description are all preferred embodiments, and the actions involved therein are not necessary for the embodiments of the present disclosure.

### A Third Embodiment

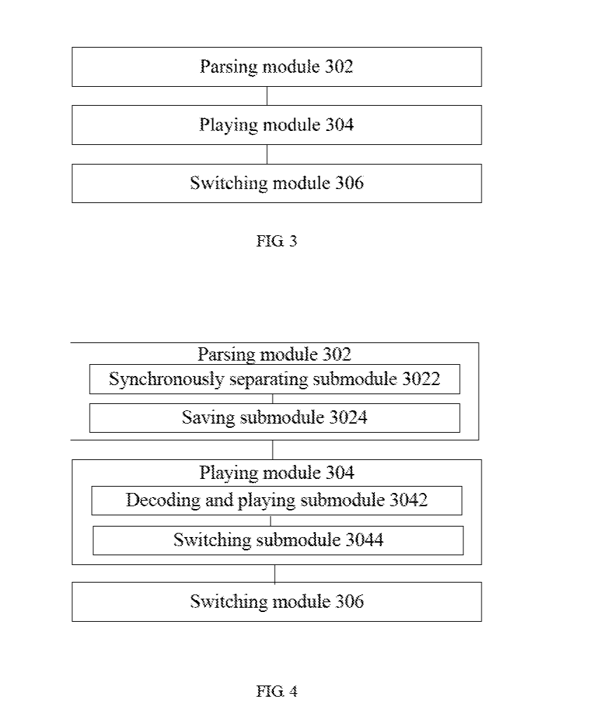

FIG. 3, which shows the structural block diagram of one embodiment of the player device of the present disclosure, the player device may specifically include the following steps: a parsing module 302, a playing module 304, and a switching module 306.

Specifically, the parsing module 302 is used to parse a file to be played to obtain one video stream and at least two audio streams and save the obtained video and audio streams into a buffer.

The playing module 304 is used to select a certain audio stream as a first audio stream, and obtain the video stream and the first audio stream from the buffer for decoding and playing, and stop decoding the first audio stream, and obtain the video stream and a second audio stream from the buffer for decoding and playing.

The switching module 306 is used to receive an audio switching instruction, and determine one other channel of audio as the second audio stream according to the audio switching instruction.

In conclusion, the player parses the file to be played to obtain one video stream and at least two audio streams, and saves the obtained video and audio streams into the buffer, i.e., decodes and saves the audio streams into the buffer on initialization. After the first audio stream is selected, and decoded and played synchronously with the video stream, if the audio switching instruction is received, the second audio stream for switching is determined. Decoding of the first audio stream is stopped, and the video stream and the second audio stream are obtained from the buffer for decoding and playing. Reparsing and readdressing are avoided; therefore, the time of addressing is saved, and the efficiency of switching is improved.

### A Fourth Embodiment

Referring to FIG. 4, which shows the structural block diagram of another embodiment of the player device of the present disclosure, the player device may specifically include the following steps:
a parsing module 302, a playing module 304, and a switching module 306.

The parsing module 302 is used to parse a file to be played to obtain one video stream and at least two audio streams and save the obtained video and audio streams into a buffer.

In a preferred embodiment of the present disclosure, the parsing module 302 it includes a synchronously separating submodule 3022 and a saving submodule 3024.

The synchronously separating submodule 3022 is used to parse the file to be played to synchronously separate one video stream and at least two audio streams therefrom.

The saving submodule 3024 is used to save the one video stream and the at least two audio streams into the buffer.

Further, in a preferred embodiment of the present disclosure, the synchronously separating submodule 3022 is used to identify data of a plurality of streams in the file to be played by means of a multistage parser, and synchronously parse the identified data of each stream to separate one video stream and at least two audio streams therefrom.

The playing module 304 is used to select a certain audio stream as a first audio stream, and obtain the video stream and the first audio stream from the buffer for decoding and playing, and stop decoding the first audio stream, and obtain the video stream and a second audio stream from the buffer for decoding and playing.

In a preferred embodiment of the present disclosure, the playing module 304 includes a decoding and playing submodule 3042, and a switching submodule 3044.

Specifically, the decoding and playing submodule 3042 is used to obtain the video stream from the buffer for decoding and playing by means of a first decoder, and obtain the first audio stream from the buffer for decoding and playing by means of a second decoder.

The switching submodule 3044 is used to deactivate the second decoder to stop decoding the first audio stream, and activate a third decoder.

In an optional embodiment, the decoding and playing submodule 3042 is used to obtain the second audio stream from the buffer for decoding and playing by means of the third decoder while obtaining the video stream from the buffer for decoding and playing by means of the first decoder.

In another preferred embodiment of the present disclosure, the decoding and playing submodule 3042 is used to obtain a decoder time stamp from the buffer by means of the third decoder, and obtain the second audio stream according to the decoder time stamp, and then decode and play the second audio stream.

The switching module 306 is used to receive an audio switching instruction, and determine one other channel of audio as the second audio stream according to the audio switching instruction.

In conclusion, according to this embodiment of the present disclosure, the player parses the file to be played to obtain one video stream and at least two audio streams, and saves the obtained video and audio streams into the buffer, i.e., decodes and saves the audio streams into the buffer on initialization. After the first audio stream is selected, and decoded and played synchronously with the video stream, if the audio switching instruction is received, the second audio stream for switching is determined. Decoding of the first audio stream is stopped, and the video stream and the second audio stream are obtained from the buffer for decoding and playing. Reparsing and readdressing are avoided; therefore, the time of addressing is saved, and the efficiency of switching is improved. The third decoder obtains the decoder time stamp from the buffer, obtains the second audio stream according to the decoder time stamp, and decodes and plays the second audio stream. By determining the playing starting point of the second audio stream according to the decoder time stamp, the time is more accurate, and more fluent audio switching can be achieved.

In regard to the device embodiments, they are just simply described as being substantially similar to the method embodiments, and the correlations therebetween just refer to part of the descriptions of the method embodiments.

Each embodiment in this description is described in a progressive manner. Descriptions emphasize on the differences of each embodiment from other embodiments, and same or similar parts of the embodiments just refer to each other.

A person skilled in the art should understand that the embodiments of the present disclosure may be provided as methods, devices, or computer program products. Hence, the embodiments of the present disclosure may be in the form of complete hardware embodiments, complete software embodiments, or a combination of embodiments in both software and hardware aspects. Moreover, the embodiments of the present disclosure may be in the form of computer program products executed on one or more computer-readable storage mediums including but not limited to a magnetic disk memory, a CD-ROM, an optical memory, etc.) containing therein computer-executable program codes.

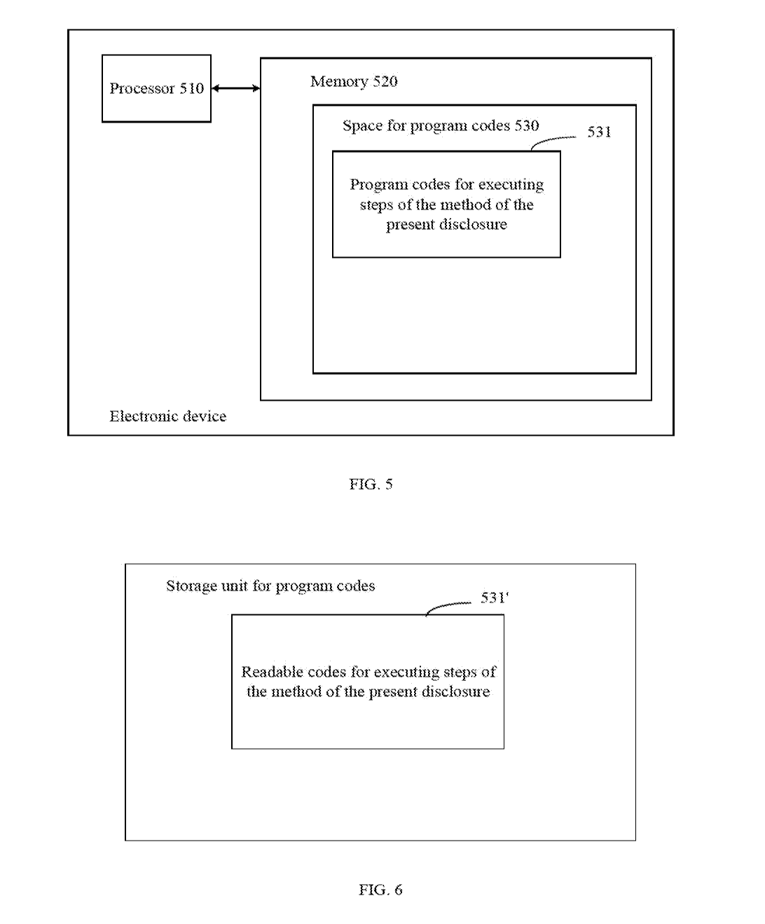

For example, FIG. 5 illustrates a block diagram of an electronic device for executing the method according the disclosure, the electronic device may be the terminal device above. Traditionally, the electronic device includes a processor 510 and a computer program product or a computer readable medium in form of a memory 520. The memory 520 could be electronic memories such is flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc. similar to the memory 520 of the electronic device as shown in FIG. 5. The program codes may be compressed for example in an appropriate form. Usually, the memory cell includes computer readable codes 531′ which can be read for example by processors 510. When these codes are operated on the electronic device, the electronic device may execute respective steps in the method as described above.

The embodiments of the present disclosure are described with reference to the flow diagrams and/or the block diagrams of the method, the terminal device (system), and the computer program product(s) according to the embodiments of the present disclosure. It should be appreciated that computer prop-am instructions may be adopted to implement each flow and/or block in each flow diagram and/or each block diagram, and a combination of the flows and/or the blocks in each flow diagram and/or each block diagram. These computer program instructions may be provided to a general-purpose computer, a special-purpose computer, an embedded processor or a processor of other programmable data processing terminal equipment to generate a machine, such that the instructions executed by the computer or the processor of other programmable data processing terminal equipment create a device for implementing functions specified in one flow or multiple flows of each flow and/or one block or multiple blocks of each block diagram.

These computer program instructions may also be stored in a computer-readable memory that is capable of guiding a computer or other programmable data processing terminal equipment to work in a specific mode, such that the instructions stored in the computer-readable memory create a manufacture including instruction device for implementing functions specified in one flow or multiple flows of each flow diagram and/or one block or multiple blocks of each block diagram.

Further, these computer program instructions may be loaded on a computer or other programmable data processing terminal equipment, such that a series of operation steps are executed on the computer or the other programmable data processing terminal equipment to generate processing implemented by the computer; in this way, the instructions executed on the computer or the other programmable data processing terminal equipment provide steps for implementing functions specified in one flow or multiple flows of each flow diagram and/or one block or multiple blocks of each block diagram.

Although the preferred embodiments amongst the embodiments of the present disclosure are already described, those skilled in the art can make another alterations and modifications to these embodiments once they learn about the basic creative concept. Hence, the appended claims are meant to be interpreted as including the preferred embodiments and all the alterations and modifications falling into the scope of the embodiments of the present disclosure.

Finally, it still needs to be noted that relational terms such as first, second, and the like in this text are merely used for differentiating one entity or operation from another entity or operation rather than definitely requiring or implying any actual relationship or order between these entities or operations. In addition, the terms “including” and “comprising”, or any other variants thereof are intended to contain non-exclusive including, such that a process, a method, an article or a terminal device including a series of elements includes not only those elements, but also other elements not explicitly listed, or further includes inherent elements of the process, the method, the article or the terminal device. Without more limitations, elements defined by the sentence of “including a . . . ” shall not be exclusive of additional same elements also existing in the process, the method, the article or the terminal device.

The method for playing a video and the player device, which are provided by the present disclosure, are introduced above in detail. Specific examples are applied in this text to elaborate the principle and the embodiments of the present disclosure. The above descriptions of the embodiments are merely intended to help understanding the methods of the present disclosure and the core concept thereof. Meanwhile, for a person skilled in the art, alterations may be made to the specific embodiments and the application scope according to the concept of the present disclosure. In conclusion, the contents of this description should not be interpreted as limitations to the present disclosure.

The electronic device in embodiment of the present disclosure may have various types, which include but are not limited to:
(1) a mobile terminal device having the characteristics of having mobile communication functions and mainly aiming at providing voice and data communication. This type of terminals include mobile terminals (such as iPhone), multi-functional mobile phones, functional mobile phones and lower-end mobile phones, etc.;
(2) an ultra portable personal computing device belonging to personal computer scope, which has computing and processing ability and has mobile internet characteristic. This type of terminals include personal digital assistant (PDA) devices, mobile internee device (MID) devices and ultra mobile personal computer (UMPC) devices, such as iPad;
(3) a portable entertainment device which may display and play multi-media contents, This type of devices include audio players, video players (such as an iPod), handheld game players, e-books, intelligent toy, and portable vehicle-mounted navigation devices;
(4) a server providing computing service, the server includes a processor, a hard disk, a memory and a system bus. The server has the same architecture as a computer, whereas, it is required higher in processing ability, stableness, reliable ability, safety, expandable ability, manageable ability etc. since the server is required to provide high reliable service;
(5) other electronic device having data interaction functions.

The device embodiment(s) described above is (are) only schematic, the units illustrated as separated parts may be or may not be separated physically, and the pasts shown in unit may be or may not be a physical unit. That is, the parts may be located at one place or distributed in multiple network units. A skilled person in the art may select part or all modules therein to realize the objective of achieving the technical solution of the embodiment. Through the description of the above embodiments, a person skilled in the art can clearly blow that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A method for playing a video, comprising:
at an electronic device:
parsing a file to be played to obtain one video stream and at least two audio streams by a player and saving the video and audio streams into a buffer;
selecting a certain audio stream as a first audio stream, and obtaining the video stream and the first audio stream from the buffer for decoding and playing;
receiving an audio switching instruction, and determining one other channel of audio as a second audio stream according to the audio switching instruction;
stopping decoding the first audio stream, and obtaining the video stream and the second audio stream from the buffer for decoding and playing.

2. The method according to claim 1, wherein parsing the file to be played to obtain one video stream and at least two audio streams by the player and saving the video and audio streams into the buffer comprises:
parsing the file to be played to synchronously separate one video stream and at least two audio streams therefrom by the player;
saving the one video stream and the at least two audio streams into the buffer.

3. The method according to claim 2, wherein parsing the file to be played to synchronously separate one video stream and at least two audio streams therefrom by the player comprises:
identifying data of a plurality of streams in the file to be played by the payer using a multistage parser;
synchronously parsing the identified data of each stream to separate one video stream and at least two audio streams therefrom.

4. The method according to claim 1, wherein obtaining the video stream and the first audio stream from the buffer for decoding and playing comprises:
obtaining the video stream from the buffer for decoding and playing by means of a first decoder, and obtaining the first audio stream from the buffer for decoding and playing by means of a second decoder.

5. The method according to claim 4, wherein stopping decoding the first audio stream and obtaining the video stream and the second audio stream from the buffer for decoding and playing comprises:
deactivating the second decoder to stop decoding the first audio stream and activating a third decoder;
obtaining the second audio stream from the buffer for decoding and playing by means of the third decoder while obtaining the video stream from the buffer for decoding and playing by means of the first decoder.

6. The method according to claim 5, wherein obtaining the second audio stream from the buffer for decoding and playing by means of the third decoder comprises:
obtaining a decoder time stamp from the buffer by the third decoder;
obtaining the second audio stream according to the decoder time stamp, and decoding and playing the second audio stream.

7. An electronic device, comprising:
at least one processor; and
a memory communicably connected with the at least one processor for storing instructions executable by the at least one processor, wherein execution of the instructions by the at least one processor causes the at least one processor to:
parse a file to be played to obtain one video stream and at least two audio streams and save the obtained video and audio streams into a buffer;
select a certain audio stream as a first audio stream, and obtain the video stream and the first audio stream from the buffer for decoding and playing, and stop decoding the first audio stream, and obtain the video stream and a second audio stream from the buffer for decoding and playing;
receive an audio switching instruction, and determine one other channel of audio as the second audio stream according to the audio switching instruction.

8. The electronic device according to claim 7, wherein parse a file to be played to obtain one video stream and at least two audio streams and save the obtained video and audio streams into a buffer comprises:
parse the file to be played to synchronously separate one video stream and at least two audio streams therefrom;
save the one video stream and the at least two audio streams into the buffer.

9. The electronic device according to claim 8, wherein parse the file to be played to synchronously separate one video stream and at least two audio streams therefrom comprises: identify data of a plurality of streams in the file to be played by means of a multistage parser, and synchronously parse the identified data of each stream to separate one video stream and at least two audio streams therefrom.

10. The electronic device according to claim 7, wherein obtain the video stream and the first audio stream from the buffer for decoding and playing comprises:
obtain the video stream from the buffer for decoding and playing by means of a first decoder, and obtain the first audio stream from the buffer for decoding and playing by means of a second decoder.

11. The electronic device according to claim 10. wherein stop decoding the first audio stream and obtain the video stream and the second audio stream from the buffer for decoding and playing comprises:
deactivate the second decoder to stop decoding the first audio stream, and activate a third decoder;
obtain the second audio stream from the buffer for decoding and playing by means of the third decoder while obtaining the video stream from the buffer for decoding and playing by means of the first decoder.

12. The electronic device according to claim 11, wherein obtaining the second audio stream from the buffer for decoding and playing by means of the third decoder comprises:
obtain a decoder time stamp from the buffer by means of the third decoder, and obtain the second audio stream according to the decoder time stamp, and then decode and play the second audio stream.

13. A non-transitory computer-readable medium, storing executable instructions that, when executed by an electronic device, cause the electronic device to:
parse is file to be played to obtain one video stream and at least two audio streams by a player and saving the video and audio streams into a buffer;
select a certain audio stream as a first audio stream, and obtaining the video stream and the first audio stream from the buffer for decoding and playing;
receive an audio switching instruction and determining one other channel of audio as a second audio stream according to the audio switching instruction:
stop decoding the first audio stream, and obtain the video stream and the second audio stream from the buffer for decoding and playing.

14. The non-transitory computer-readable medium according to claim 13, wherein parse the file to be played to obtain one video stream and at least two audio streams by the player and saving the video and audio streams into the buffer comprises:
parsing the file to be played to synchronously separate one video stream and at least two audio streams therefrom by the player;
saving the one video stream and the at least two audio streams into the buffer.

15. The non-transitory computer-readable medium according to claim 14, wherein parse the file to be played to synchronously separate one video stream and at least two audio streams therefrom by the player comprises:
identifying data of a plurality of streams in the file to be played by the payer using a multistage parser;
synchronously parsing the identified data of each stream to separate one video stream and at least two audio streams therefrom.

16. The non-transitory computer-readable medium according to claim 13, wherein obtain the video stream and the first audio stream from the buffer for decoding and playing comprises:
obtaining the video stream from the buffer for decoding and playing by means of a first decoder, and obtaining the first audio stream from the buffer for decoding and playing by means of a second decoder.

17. The non-transitory computer-readable medium according to claim 16, wherein stop decoding the first audio stream and obtain the video stream and the second audio stream from the buffer for decoding and playing comprises:
deactivating the second decoder to stop decoding the first audio stream, and activating a third decoder;
obtaining the second audio stream from the buffer for decoding and playing by means of the third decoder while obtaining the video stream from the buffer for decoding and playing by means of the first decoder.

18. The non-transitory computer-readable medium according to claim 17, wherein obtain the second audio stream from the buffer for decoding and playing by means of the third decoder comprises:
obtaining a decoder time stamp from the buffer by the third decoder;
obtaining the second audio stream according to the decoder time stamp, and decoding and playing the second audio stream.
